(19) United States
(12) Patent Application Publication
(10) Pub. No.: US 2024/0411462 A1
(43) Pub. Date: Dec. 12, 2024

(54) Local Triggering of Processing-in-Memory Operations

(71) Applicant: Advanced Micro Devices, Inc., Santa Clara, CA (US)

(72) Inventors: Mohamed Assem Abd ElMohsen Ibrahim, Santa Clara, CA (US); Shaizeen Dilawarhusen Aga, Santa Clara, CA (US); Mahzabeen Islam, Dripping Springs, TX (US)

(73) Assignee: Advanced Micro Devices, Inc., Santa Clara, CA (US)

(21) Appl. No.: 18/207,314

(22) Filed: Jun. 8, 2023

(51) Int. Cl. G06F 3/06

(52) U.S. Cl. CPC G06F 3/0625; G06F 3/0659; G06F 3/0673

(57) ABSTRACT

Local and dynamic triggering of operations executed by a processing-in-memory component is described. In accordance with the described techniques, a processing-in-memory component receives a command from a host for execution by the processing-in-memory component. The processing-in-memory component references a tracking table that includes at least one entry associated with an operation performed as part of executing the command and identifies at least one additional command to be triggered locally after executing the command received from the host. Responsive to identifying that conditions associated with the at least one additional command are satisfied, the processing-in-memory component executes the at least one additional command, independent of instructions from the host.

### BACKGROUND

Computing device architectures utilize accelerators to optimize pipelines with different compute and memory requirements. For instance, a host that would otherwise be tasked with performing computations instead instructs an accelerator to perform the computations. The host then reads results generated by the accelerator from memory after the accelerator performs the computations and writes generated results to memory. One example of an accelerator is a processing-in-memory (PIM) component, which allows memory-intensive computations to be performed in memory.

This contrasts with standard computer architectures which communicate data back and forth between a memory and a remote processing unit. In terms of data communication pathways, remote processing units of conventional computer architectures are further away from memory than PIM components. As a result, conventional computer architectures suffer from increased data transfer latency, require additional energy and computational resource consumption to transfer data from memory, and consume bandwidth during data transfer, which can decrease overall computer performance. Thus, processing-in-memory components and other accelerators enable increased computer performance while reducing data transfer latency, computational resource consumption, and bandwidth consumption in comparison to conventional computer architectures that implement remote processing hardware.

### BRIEF DESCRIPTION OF THE DRAWINGS

FIG. 1 is a block diagram of an example system having a host with a core and a memory module with a memory and a processing-in-memory component that implements a command trigger unit.

FIG. 2 depicts an example of a tracking table implemented by the command trigger unit of a processing-in-memory component.

FIG. 3 depicts an example of different processing-in-memory components using command trigger units to dynamically respond to a command from a host.

FIG. 4 depicts a procedure in an example implementation of dynamically triggering execution of commands locally at a processing-in-memory component.

FIG. 5 depicts a procedure in an example implementation of causing a processing-in-memory component to locally trigger execution of additional commands based on a command sent from a host to the processing-in-memory component.

### DETAILED DESCRIPTION

In an effort to increase computational efficiency, computing device architectures are designed to include accelerators that offload compute tasks from a processor device that would otherwise be used to perform the compute tasks in an architecture without accelerators. One such example of an accelerator is a processing-in-memory component. In conventional processing-in-memory system architectures, a host processor coordinates overall system execution and assigns work to processing-in-memory components by broadcasting commands to the processing-in-memory components. Such conventional system architectures are designed to handle regular workloads where all processing-in-memory components execute the same computations on different data. However, these conventional system architectures are not well suited to handle divergent workloads, where different computations are required to be performed by different processing-in-memory components. In order to handle these divergent workloads, conventional system architectures force the host to sequentially issue separate commands to the different processing-in-memory components to cause performance of the different computations.

Divergent workloads are increasingly implemented by various machine learning models and their preprocessing pipelines, such as models configured for genomics, graph analytics, and so forth. Other conventional system architectures that do not include processing-in-memory components force a host to perform all operations of a workload. However, forcing a host to perform all operations of a workload is inefficient when compared to a system architecture that includes processing-in-memory components, as data-intensive computations benefit from increased memory bandwidth due to processing-in-memory components being in or near memory, which provides significantly increased memory bandwidth relative to that available to a host processor.

To address these conventional problems, a command trigger unit for a processing-in-memory component is described. The command trigger unit enables a processing-in-memory component to trigger different commands locally and dynamically for execution by the processing-in-memory component, without intervention by or instruction from a host processor. Advantageously, the command trigger unit is programmable in an application-specific manner, such that an application developer and/or a compiler is able to predefine how execution of one processing-in-memory command will trigger execution of additional processing-in-memory commands to best suit the needs of the application.

In accordance with one or more implementations, a command trigger unit includes a tracking table that includes at least one entry specifying an additional command to be triggered locally for execution by a processing-in-memory component, as well as conditions that define when the additional command is triggered. Each entry of the tracking table includes information describing a data storage location that is accessible by the processing-in-memory component, such as a register of the processing-in-memory component. The command trigger unit is configured to identify when execution of a command received from a host processor is associated with a data storage location described in a tracking table entry.

For instance, in an example scenario where a command received from a host causes a processing-in-memory component to write data to a local register, the command trigger unit of the processing-in-memory component is configured to check whether the local register is identified in an entry of the tracking table. In response to detecting that the data storage location associated with a command is included in a tracking table entry, the command trigger unit evaluates whether conditions of the entry are satisfied. If conditions of the entry are satisfied, the command trigger unit schedules an additional command defined by the entry for execution by the processing-in-memory component.

Although techniques are described herein with respect to a single accelerator (e.g., an accelerator configured as a processing-in-memory component), the described techniques are configured for implementation by multiple accelerators in parallel (e.g., simultaneously). For instance, in an example scenario where memory is configured as dynamic random-access memory (DRAM), a processing-in-memory component is included at each hierarchical DRAM component (e.g., channel, bank, array, and so forth). Each processing-in-memory component is configured to trigger execution of additional commands as described in a common tracking table (e.g., a tracking table shared by multiple processing-in-memory components) or as described in a tracking table specific to the processing-in-memory component, responsive to identifying that conditions for a tracking table entry are satisfied by data local to the processing-in-memory component (e.g., data stored in the corresponding hierarchical DRAM component).

The techniques described herein thus enable a host processor to cause execution of divergent operations by different processing-in-memory components based on a single command broadcast from the host processor to the different processing-in-memory components. Advantageously, by triggering additional commands locally, a processing-in-memory component is configured to perform one or more operations independent of (e.g., without) traffic on a connection that communicatively couples the processing-in-memory component to a host processor. The described techniques further advantageously save cycles of the remote host processor, which reduces system power consumption and/or frees the host processor to perform additional operations relative to conventional systems.

In some aspects, the techniques described herein relate to a device including a processing-in-memory component configured to receive a command, generate an output by executing the command, and execute at least one additional command based on an entry of a tracking table, the entry being associated with an operation performed as part of executing the command.

In some aspects, the techniques described herein relate to a device, wherein the operation includes providing the output to a destination, wherein the command is received with information identifying the destination and the at least one additional command is executed in response to writing the output to the destination.

In some aspects, the techniques described herein relate to a device, wherein the destination includes a storage location local to the processing-in-memory component or a location in memory of a memory module implementing the processing-in-memory component.

In some aspects, the techniques described herein relate to a device, wherein the operation includes reading data from a location and executing the at least one additional command is performed in response to reading the data from the location.

In some aspects, the techniques described herein relate to a device, wherein the command includes a command trigger bit and the processing-in-memory component executes the at least one additional command in response to the command trigger bit being a predefined value.

In some aspects, the techniques described herein relate to a device, wherein the at least one additional command is executed in response to the processing-in-memory component identifying that a condition in the entry is satisfied.

In some aspects, the techniques described herein relate to a device, wherein the condition in the entry is satisfied responsive to a data storage location, other than a destination for the output of the command, storing a value indicated in the entry of the tracking table.

In some aspects, the techniques described herein relate to a device, further including a memory controller, wherein the processing-in-memory component is further configured to instruct the memory controller to delay scheduling of additional commands in response the at least one additional command being executed based on the entry of the tracking table.

In some aspects, the techniques described herein relate to a device, wherein the tracking table is stored locally at the processing-in-memory component or at a storage location in memory that is accessible by the processing-in-memory component.

In some aspects, the techniques described herein relate to a device, wherein the tracking table is programmed by a host from which the command is received.

In some aspects, the techniques described herein relate to a device, wherein the processing-in-memory component is further configured to transmit a notification to the host indicating performance of the at least one additional command in response to executing the at least one additional command.

In some aspects, the techniques described herein relate to a device, wherein the entry of the tracking table includes a field describing a threshold number of times the at least one additional command is to be executed, wherein the processing-in-memory component is configured to execute the at least one additional command responsive to determining that the threshold number of times the at least one additional command is to be executed has not been exceeded.

In some aspects, the techniques described herein relate to a device, wherein the processing-in-memory component is configured to execute the at least one additional command independent of traffic on a connection between the processing-in-memory component and a host from which the command is received.

In some aspects, the techniques described herein relate to a device, further including a different processing-in-memory component configured to receive the command, generate a different output by executing the command, and execute another command that is different than the at least one additional command based on a different entry of the tracking table, the different entry being associated with the different output.

In some aspects, the techniques described herein relate to a device including a host configured to send a command for execution by a processing-in-memory component, and cause the processing-in-memory component to execute an additional command based on a tracking table that is stored at the processing-in-memory component and includes an entry associated with an operation performed as part of executing the command.

In some aspects, the techniques described herein relate to a device, wherein the host is further configured to program the tracking table by populating the tracking table with entries prior to sending the command.

In some aspects, the techniques described herein relate to a device, further including a memory controller, wherein the host is configured to send the command to the memory controller for scheduling at the processing-in-memory component with an indication that the command is configured to cause execution of the additional command locally at the processing-in-memory component.

In some aspects, the techniques described herein relate to a device, wherein the host is further configured to execute at least one operation while the processing-in-memory component is executing the additional command.

In some aspects, the techniques described herein relate to a device, wherein the processing-in-memory component is caused to execute the additional command independent of traffic on a connection between the host and the processing-in-memory component.

In some aspects, the techniques described herein relate to a method including receiving, at an accelerator, a command from a host, generating, by the accelerator, an output by executing the command, and executing, by the accelerator, at least one additional command based on an entry of a tracking table, the entry being associated with an operation performed as part of executing the command.

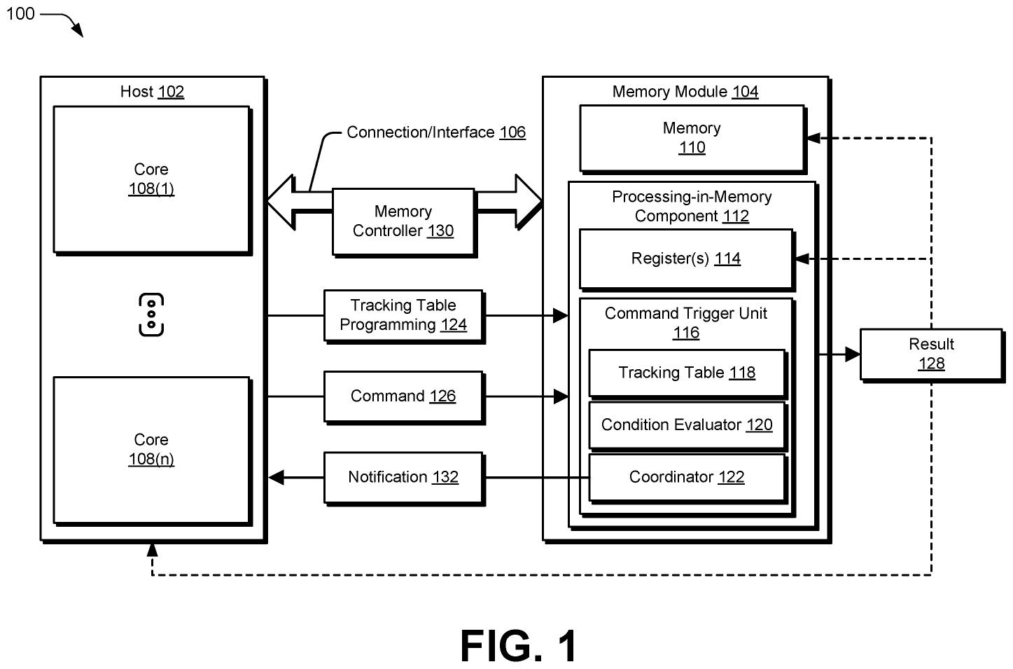

FIG. 1 is a block diagram of a system 100 that includes a host with a core and further includes a memory module with a memory and a processing-in-memory component. In particular, the system 100 includes host 102 and memory module 104, where the host 102 and the memory module 104 are communicatively coupled via connection/interface 106. In one or more implementations, the host 102 includes at least one core 108. In some implementations, the host 102 includes multiple cores 108. For instance, in the illustrated example of FIG. 1, host 102 is depicted as including core 108(1) and core 108(n), where n represents any integer. The memory module 104 includes memory 110 and processing-in-memory component 112.

In accordance with the described techniques, the host 102 and the memory module 104 are coupled to one another via a wired or wireless connection, which is depicted in the illustrated example of FIG. 1 as the connection/interface 106. Example wired connections include, but are not limited to, buses (e.g., a data bus), interconnects, traces, and planes. Examples of devices in which the system 100 is implemented include, but are not limited to, supercomputers and/or computer clusters of high-performance computing (HPC) environments, servers, data center servers, personal computers, laptops, desktops, game consoles, set top boxes, tablets, smartphones, mobile devices, virtual and/or augmented reality devices, wearables, medical devices, systems on chips, and other computing devices or systems.

The host 102 is an electronic circuit that performs various operations on and/or using data in the memory 110. Examples of the host 102 and/or the core 108 include, but are not limited to, a central processing unit (CPU), a graphics processing unit (GPU), a field programmable gate array (FPGA), an accelerated processing unit (APU), and a digital signal processor (DSP). For example, the core 108 is a processing unit that reads and executes instructions (e.g., of a program), examples of which include to add, to subtract, to move data, to branch, and so forth.

In one or more implementations, the memory module 104 is a circuit board (e.g., a printed circuit board), on which the memory 110 is mounted and includes the processing-in-memory component 112. In some variations, one or more integrated circuits of the memory 110 are mounted on the circuit board of the memory module 104, and the memory module 104 includes one or more processing-in-memory components 112. Examples of the memory module 104 include, but are not limited to, a TransFlash memory module, a single in-line memory module (SIMM), and a dual in-line memory module (DIMM). In one or more implementations, the memory module 104 is a single integrated circuit device that incorporates the memory 110 and the processing-in-memory component 112 on a single chip. In some examples, the memory module 104 is composed of multiple chips that implement the memory 110 and the processing-in-memory component 112 that are vertically (“3D”) stacked together, are placed side-by-side on an interposer or substrate, or are assembled via a combination of vertical stacking or side-by-side placement.

The memory 110 is a device or system that is used to store information, such as for immediate use in a device (e.g., by the core 108 of the host 102 and/or by the processing-in-memory component 112). In one or more implementations, the memory 110 corresponds to semiconductor memory where data is stored within memory cells on one or more integrated circuits. In at least one example, the memory 110 corresponds to or includes volatile memory, examples of which include random-access memory (RAM), dynamic random-access memory (DRAM), synchronous dynamic random-access memory (SDRAM), and static random-access memory (SRAM).

In some implementations, the memory 110 corresponds to or includes a cache memory of the core 108 and/or the host 102 such as a level 1 cache, a level 2 cache, a level 3 cache, and so forth. Alternatively or additionally, the memory 110 corresponds to or includes a near-memory cache (e.g., a local cache for the processing-in-memory component 112). Alternatively or additionally, the memory 110 represents high bandwidth memory (HBM) in a 3D-stacked implementation. Alternatively or additionally, the memory 110 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). The memory 110 is thus configurable in a variety of ways that support performance of operations using data stored in memory (e.g., of the memory 110), using processing-in-memory, without departing from the spirit or scope of the described techniques.

The processing-in-memory component 112 is an example of an accelerator utilized by the host 102 to offload performance of computations (e.g., computations that would otherwise be performed by the core 108 in a conventional computing device architecture). Although described with respect to implementation by the processing-in-memory component 112, the techniques described herein are configured for implementation by a variety of different accelerator configurations (e.g., an accelerator other than a processing-in-memory component). Generally, the processing-in-memory component 112 is configured to process processing-in-memory instructions (e.g., received from the core 108 via the connection/interface 106). The processing-in-memory component 112 is representative of a processor with example processing capabilities ranging from relatively simple (e.g., an adding machine) to relatively complex (e.g., a CPU/GPU compute core). In an example, the processing-in-memory component 112 processes instructions using data stored in the memory 110.

Processing-in-memory contrasts with standard computer architectures which obtain data from memory, communicate the data to a remote processing unit (e.g., the core 108 of the host 102), and process the data using the remote processing unit (e.g., using the core 108 of the host 102 rather than the processing-in-memory component 112). In various scenarios, the data produced by the remote processing unit as a result of processing the obtained data is written back to memory, which involves communicating the produced data over the connection/interface 106 from the remote processing unit to memory. In terms of data communication pathways, the remote processing unit (e.g., the core 108 of the host 102) is further away from the memory 110 than the processing-in-memory component 112, both physically and topologically. As a result, conventional computer architectures suffer from increased data transfer latency, reduced data communication bandwidth, and increased data communication energy, particularly when the volume of data transferred between the memory and the remote processing unit is large, which can also decrease overall computer performance.

Thus, the processing-in-memory component 112 enables increased computer performance while reducing data transfer energy as compared to standard computer architectures that implement remote processing hardware. Further, the processing-in-memory component 112 alleviates memory performance and energy bottlenecks by moving one or more memory-intensive computations closer to the memory 110. Although the processing-in-memory component 112 is illustrated as being disposed within the memory module 104, in some examples, the described benefits of triggering processing-in-memory commands are extendable to near-memory processing implementations in which an accelerator (e.g., the processing-in-memory component 112) is disposed in closer proximity to the memory 110 (e.g., in terms of data communication pathways) than the core 108 of the host 102.

The processing-in-memory component 112 is depicted as including one or more registers 114. Each of the one or more registers 114 is representative of a data storage location in the processing-in-memory component 112 that is configured to store data (e.g., one or more bits of data). Although described herein in the example context of registers, the one or more registers 114 are representative of any suitable configuration of one or more data storage components, such as a cache, a scratchpad memory, a local store, or other type of data storage component configured to store data produced by the accelerator locally (e.g., independent of transmitting data produced by the accelerator to memory of the memory module). Each of the one or more registers 114 is associated with an address that defines where data stored by the respective register is located within the processing-in-memory component 112.

By virtue of an associated address, each of the one or more registers 114 are uniquely identifiable (i.e., distinguishable from other ones of the one or more registers 114). For instance, in some implementations each of the one or more registers 114 has an identifier assigned to the register that uniquely identifies the register relative to others of the one or more registers 114. In an example scenario where the one or more registers 114 include N different registers, the system 100 uses log₂(N) bits to uniquely identify the registers 114. In other implementations, an accelerator utilizes a local cache to store data and address information uniquely identifies different locations within the cache (e.g., the one or more registers 114 are representative of different locations within a local cache for an accelerator, where the different locations are addressed by block identifiers).

In some implementations, the one or more registers 114 are representative of a scalar register, which is configured to store a single value for one or more lanes, such that different lanes store data describing a common numerical value. Alternatively or additionally, the one or more registers 114 are representative of a register configured to store multiple different values (e.g., a general purpose register). In implementations where the one or more registers 114 include a register configured to store multiple different values, different lanes of the register are capable of storing different numerical values, contrasting with the single value storage capabilities of a scalar register.

The processing-in-memory component 112 is further depicted as including a command trigger unit 116. The command trigger unit 116 is representative of functionality of the processing-in-memory component 112 that causes the processing-in-memory component 112 to locally trigger, and execute, one or more additional commands based on a command received from the host 102. To do so, the command trigger unit 116 includes a tracking table 118, a condition evaluator 120, and a coordinator 122. The tracking table 118 represents a programmable data structure that is configured to maintain information describing data storage locations to be tracked for conditions that trigger execution of an additional command, the conditions that trigger the execution of the additional command, the additional command to be triggered, and other configurable parameters that are configurable to trigger execution of the additional command, selectively and dynamically on a program-specific basis.

The condition evaluator 120 represents functionality of the processing-in-memory component 112 to evaluate whether triggering conditions are satisfied for execution of an additional command, based on information included in one or more entries of the tracking table 118. In accordance with the techniques described herein, triggering conditions are satisfied in scenarios where the processing-in-memory component 112 executes a command received from the host 102, in scenarios where the processing-in-memory component 112 executes a command triggered locally for execution (e.g., by the command trigger unit 116), or combinations thereof. The coordinator 122 represents functionality of the command trigger unit 116 to update one or more entries in the tracking table 118 and to notify other components of the system 100 (e.g., the memory controller, the host 102, and so forth) in response to an additional command being triggered locally for execution at the processing-in-memory component 112.

The host 102 is configured to program the tracking table 118 by adding an entry to the tracking table 118 for each data storage location of the memory module 104 that is intended (e.g., by an application developer) to trigger execution of an additional command by the processing-in-memory component 112. In the illustrated example of FIG. 1, the host 102 programs the tracking table 118 by communicating tracking table programming 124 to the processing-in-memory component 112, where the tracking table programming 124 includes one or more entries for populating the tracking table 118. As described in further detail below, in some implementations, the data storage location represented in a tracking table entry corresponds to one of the registers 114. Alternatively or additionally, the data storage location represented in a tracking table entry corresponds to a location in memory 110.

Although illustrated in FIG. 1 in the context of being applied to a single processing-in-memory component 112, the host 102 is configured to communicate the tracking table programming 124 to different processing-in-memory components of the memory module 104. In this manner, the tracking table programming 124 is configured to be applied to a single processing-in-memory component, across all processing-in-memory components, or to a subset of processing-in-memory components of the system 100. In some implementations, the tracking table programming 124 is representative of the host 102 populating a single entry in the tracking table 118. Alternatively, the tracking table programming 124 is representative of the host 102 populating multiple entries of the tracking table 118. In some implementations, the tracking table programming 124 further includes information that initializes values of one or more data storage locations (e.g., one or more registers 114) that correspond to entries in the tracking table 118. In this manner, the tracking table programming 124 represents functionality of the host 102 to dynamically program the command trigger unit 116 in a manner that is tailored for a specific purpose (e.g., tailored for an application that involves execution of one or more processing-in-memory commands, represented in FIG. 1 as command 126, as defined by a developer of the application).

In some implementations, the host 102 is configured to communicate the tracking table programming 124 to the processing-in-memory component 112 prior to runtime (e.g., during compilation) of an application executed by the host 102. Alternatively or additionally, the host 102 is configured to provide the tracking table programming 124 to the processing-in-memory component 112 during runtime of an application executed by the host 102. For instance, during runtime of an application that involves the processing-in-memory component 112 performing one or more operations as part of executing the command 126, the host 102 is configured to update the tracking table 118 via tracking table programming 124. As a specific example, the host 102 provides tracking table programming 124 to the processing-in-memory component 112 during runtime of an application executed at the host 102 to add and/or remove entries from the tracking table 118 in an online fashion. In this manner, the host 102 is configured to dynamically update a manner in which the processing-in-memory component 112 locally triggers execution of additional commands (e.g., responsive to receipt of the command 126 from the host 102).

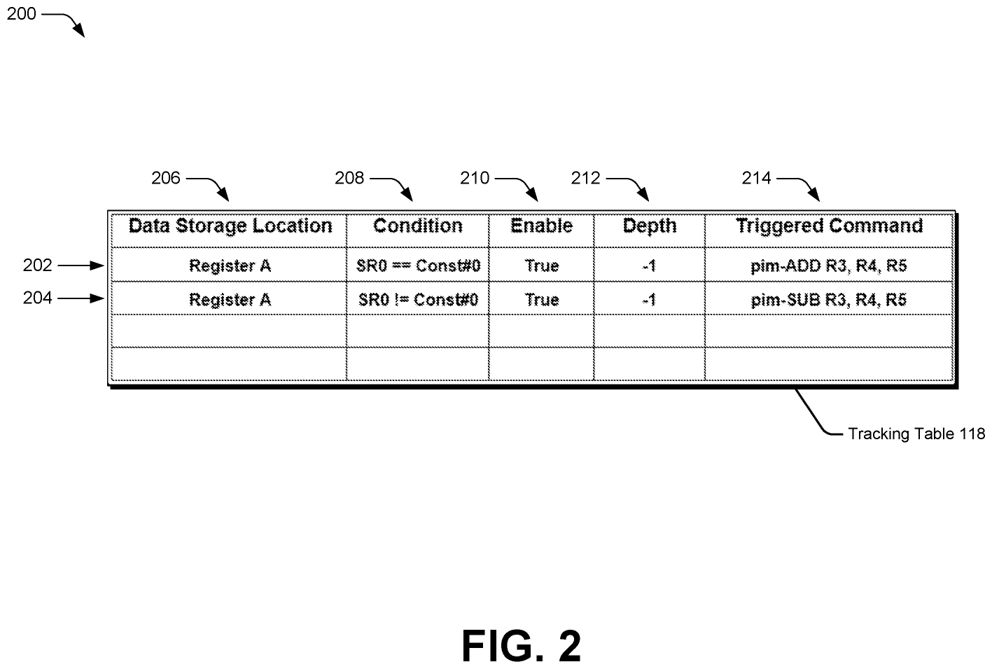

For a further description of entries included in the tracking table 118, as defined by the host 102 via tracking table programming 124, consider FIG. 2.

FIG. 2 illustrates an example 200 of the tracking table 118 in accordance with one or more implementations. In the illustrated example 200, the tracking table 118 is depicted as having two entries populated by the tracking table programming 124, where a first entry is defined by data included in row 202 of the tracking table 118 and a second entry is defined by data included in row 204 of the tracking table 118.

Each entry in the tracking table 118 is defined by various fields, which are individually represented in the illustrated example 200 by different columns of the tracking table 118. For example, column 206 includes information that describes a data storage location to be tracked by the command trigger unit 116 for locally triggering execution of an additional command (e.g., responsive to executing command 126). In an example implementation, the data storage location identified in column 206 corresponds to a register 114 of the processing-in-memory component 112 (e.g., “Register A”). The information included in column 206 is configurable in any suitable manner to identify a data storage location, such as an index for one of the registers 114 as described in a register file of the processing-in-memory component 112. Although illustrated and described herein with respect to identifying one of the registers 114, in one or more implementations the data storage location described in column 206 corresponds to a data storage location other than the one or more registers 114, such as a data storage location in a near-memory cache (e.g., a local cache for the processing-in-memory component 112), in memory 110, and so forth.

In implementations, column 206 causes the command trigger unit 116 to track all activity (e.g., reads and writes) at the identified data storage location for possible triggering of an additional command at the processing-in-memory component 112. Alternatively, in some implementations, column 206 includes information specifying a specific type of activity to track at the identified data storage location. For instance, column 206 specifies that the identified data storage location is to be monitored for a specific type of operation (e.g., reads or writes) for possible triggering of an additional command at the processing-in-memory component 112.

Column 208 includes information that describes a triggering condition to be evaluated by the condition evaluator 120, responsive to detecting activity at the data storage location identified in column 206. In implementations, the triggering condition described in column 208 involves data maintained at the data storage location identified by column 206. Alternatively, in some implementations the triggering condition described in column 208 does not involve the data storage location identified in column 206. For instance, in the illustrated example of FIG. 2, the triggering condition for the entry of row 202 specifies that an additional command is to be triggered and executed by the processing-in-memory component 112 if a value stored in scalar register zero (SRO) equals zero. The triggering condition for the entry of row 204 specifies that a different additional command is to be triggered and executed by the processing-in-memory component 112 if a value stored in SRO does not equal zero.

Thus, although the different entries of row 202 and row 204 reference a common data storage location (e.g., Register A), the triggering conditions of column 208 enable triggering of different commands at the processing-in-memory component 112 based on a current value of data stored at the common data storage location. In some implementations, the condition field for an entry in the tracking table 118 is optionally populated. In implementations where the condition field for an entry of the tracking table 118 is not populated, the condition evaluator 120 is configured to default to an interpretation that conditions are satisfied.

Column 210 includes a flag to enable or disable an entry of the tracking table 118. In the illustrated example of FIG. 2, the fields of column 210 for each of row 202 and row 204 are set to “True,” which indicates that the corresponding entries are enabled. Conversely, in an implementation where the field of column 210 for an entry indicates “False,” then triggering of the command associated with the entry is skipped, even if all other conditions for triggering the command are satisfied. In implementations where the field of column 210 is not populated, the condition evaluator 120 is configured to default to an interpretation that the entry is enabled.

Column 212 includes a “depth” value for each entry of the tracking table 118, which represents a counter indicating a threshold number of times an additional command is permitted to be triggered at the processing-in-memory component 112. As a specific example, if a value of column 212 is an integer greater than one, the integer represents the number of times the command trigger unit 116 is permitted to trigger execution of the additional command described in the entry. A depth value of an integer greater than one thus indicates that the threshold number of times the additional command is permitted to be triggered has not been exceeded. Continuing this specific example, if the value of column 212 is zero, a depth value of zero indicates that the additional command associated with the entry is not permitted to be triggered, even if all other conditions for triggering the additional command are satisfied. Further to this specific example, if the value of column 212 is negative one, such a negative value indicates that the additional command associated with the entry is permitted to be triggered an unlimited number of times. Thus, in the illustrated example of FIG. 2, column 212 indicates that the additional commands for each entry of row 202 and row 204 are permitted to be triggered without restriction as to a number of triggering instances.

Column 214 includes information describing the command to be triggered locally at the processing-in-memory component 112 (e.g., independent of an instruction from the host 102 or traffic on the interface 106 connecting the host 102 to the processing-in-memory component 112) when conditions for the entry are satisfied. Thus, when activity (e.g., a read or write operation) is detected at the data storage location identified in column 206, when the enable flag of column 210 is set to true, and when the depth value of column 212 permits triggering, when the condition described in column 208 are satisfied, the command described in column 214 is triggered for execution by the processing-in-memory component 112. In the illustrated example of FIG. 2, column 214 indicates that a processing-in-memory add operation should be performed for registers three, four, and five when conditions for the entry of row 202 are satisfied. Similarly, column 214 indicates that a processing-in-memory subtract operation should be performed for registers three, four, and five when conditions for the entry of row 204 are satisfied.

Although described and illustrated in the context of being included in the tracking table 118, in some implementations column 214 includes a pointer to a processing-in-memory command maintained elsewhere in the system 100. For instance, in some implementations the data for an entry of column 214 is configured as a pointer to a command maintained in the one or more registers 114, in the memory 110, or in any suitable data storage location of the system 100 that is accessible by the processing-in-memory component 112.

In some implementations, the tracking table 118 is configured to include one or more additional fields for an entry, which are not depicted in the illustrated example of FIG. 2. For instance, a tracking table entry is configurable to include an activation count field that includes a value to selectively delay triggering of a command described in column 214. As an example, the activation count field is configurable to specify an integer value greater than one, and is decremented each time conditions for the entry are satisfied. The activation count field does not permit triggering of the command described in column 214 until it specifies a value of zero.

Alternatively or additionally, a tracking table entry is configurable to include a “group” field, which is useable to define multiple tracking table entries that should be grouped together. In this manner, the group field of a tracking table entry enables the coordinator 122 to update fields (e.g., enable fields specified in column 210 and depth values specified in column 212) simultaneously for all tracking table 118 entries belonging to a common group, rather than updating fields for a single entry. In one specific example implementation, tracking table entries corresponding to a common data storage location (e.g., entries associated with a same register 114) are grouped together.

Alternatively or additionally, a tracking table entry is configurable to include a “used later” field, which indicates whether a triggered command associated with the entry will be used later (e.g., during execution of an application by the host 102). In implementations where the host 102 is aware as to whether a command will be subsequently triggered locally at the processing-in-memory component 112, the “used later” field can be defined to indicate true or false. Alternatively or additionally, in some specific scenarios it is advantageous to reset the depth value of column 212 (e.g., to its original value as specified by the tracking table programming 124). In such specific scenarios, a tracking table entry is configurable to include a field that defines an original depth value of column 212, thus enabling subsequent resetting of the depth value.

Returning to FIG. 1, during runtime of an application, the host 102 transmits (e.g., broadcasts to multiple processing-in-memory components of the memory module 104 or to a single processing-in-memory component 112) the command 126 for execution by one or more processing-in-memory components. In implementations, the command 126 includes an additional bit, described herein as the command trigger unit bit (the “CTU bit”). The CTU bit of the command 126 is configurable by the host 102 to indicate whether the command trigger unit 116 should check the tracking table 118 to identify whether executing the command 126 will trigger execution of at least one additional command by the processing-in-memory component 112. In this manner, when the CTU bit of the command 126 is set to a predefined value, the predefined value causes the command trigger unit 116 to check the tracking table 118.

For instance, in implementations where the CTU bit of the command 126 is set to one, the command trigger unit 116 is instructed to check the tracking table 118 to identify whether an entry triggers execution of an additional command after the processing-in-memory component 112 executes the command 126. Alternatively, in implementations where the CTU bit is set to zero, the command trigger unit 116 does not check the tracking table 118 and the processing-in-memory component 112 executes one or more operations of the command 126 without triggering execution of an additional command. The CTU bit of the command 126 thus enables the host 102 to selectively enable the triggering mechanism of the command trigger unit 116 when intended (e.g., by a developer of an application that involves execution of the command 126 by the processing-in-memory component 112).

Upon receipt of the command 126, and in response to detecting that the CTU bit of the command 126 is set (e.g., equals one), the command trigger unit 116 extracts a data storage location identifier (e.g., a register identifier) from the command 126. In some implementations, the data storage location identifier is represented as an output destination for writing a result 128 generated as part of executing the command 126. As depicted in the illustrated example of FIG. 1, the processing-in-memory component 112 is configured to output the result 128 to any suitable location of the system 100, such as to the host 102, to memory 110, to one or more registers 114, combinations thereof, and so forth. In accordance with one or more implementations, data storage locations listed in the tracking table 118 (e.g., in column 206 of example 200) are indexed using identifiers of the one or more registers 114 as keys, which reduces time and computational cost associated with searching the tracking table 118.

In response to identifying one or more matching entries in the tracking table 118 for the data storage location identifier extracted from the command 126, the condition evaluator 120 identifies whether the enable field and the depth value for an entry indicate that the additional command of the entry is permitted for triggering (e.g., whether the enable field equals “true” and the depth value is not equal to zero). If the depth value and enable field permit triggering of the entry's additional command, the condition evaluator 120 evaluates the triggering condition (e.g., the condition defined in column 208 of example 200). In response to determining that the triggering condition for the entry is satisfied, the command trigger unit 116 causes the processing-in-memory component 112 to execute the additional command of the entry (e.g., the additional command defined in column 214 of example 200).

In accordance with the techniques described herein, in implementations there is at most one matching entry to trigger an additional command for execution by the processing-in-memory component 112. Alternatively, in implementations where the tracking table 118 includes multiple entries with conditions indicating that an additional command should be triggered in response to executing command 126, the command trigger unit 116 is configured to stop checking the tracking table 118 after identifying a first matching entry. Alternatively or additionally, the tracking table 118 is configurable to include an additional “priority” field for each entry, where multiple matching entries are arbitrated based on associated priority, such that a highest priority entry is used to trigger execution of an additional command by the processing-in-memory component 112. Alternatively, in some implementations the condition evaluator 120 is configured to prevent situations where multiple entries are triggered in response to executing the command 126 by overwriting entries with the same triggering data storage location and overlapping conditions.

In response to triggering execution of an additional command by the processing-in-memory component 112, the coordinator 122 is configured to update one or more fields of the triggered tracking table 118 entry to reflect execution of the additional command. For instance, in response to the command trigger unit 116 triggering execution of an entry's command, the coordinator 122 is configured to decrement the entry's depth value, unless the depth value indicates zero or negative one. Alternatively or additionally, the coordinator 122 is configured to update the enable flag of an entry to “False” if a depth value for the entry has reached zero. In some implementations, the coordinator 122 is configured to periodically (e.g., independent of a triggering event) evaluate entries in the tracking table and remove entries with an enable flag indicating “False.” Alternatively or additionally, the coordinator 122 is configured to decrement an activation count field of an entry in response to detecting a triggering event for the entry. The coordinator 122 thus represents functionality of the command trigger unit 116 to update the tracking table 118 as the processing-in-memory component 112 executes commands on behalf of the host 102.

An additional command triggered in response to executing the command 126 is then scheduled by the coordinator 122 for execution by the processing-in-memory component 112. Although described above in the context of triggering a single additional command for execution by the processing-in-memory component 112, in some implementations the tracking table 118 includes an entry indicating that multiple commands (e.g., a list of processing-in-memory commands) should be triggered for execution in response to executing command 126. In such a situation where the tracking table 118 entry indicates that multiple commands are triggered for execution, the coordinator 122 is configured to keep track of the list of commands and schedule them for execution by the processing-in-memory component 112 until completion.

In accordance with one or more implementations, an additional command triggered by the command trigger unit 116 is configurable to cause triggering of a subsequent command for execution by the processing-in-memory component 112. In such implementations, additional command specified in an entry of the tracking table 118 is configured to include a CTU bit set to one, which causes the command trigger unit 116 to check the tracking table 118 to identify whether conditions exist for triggering a subsequent command for execution by the processing-in-memory component 112. In some implementations, the command trigger unit 116 is configured to do so by leveraging an additional field in the tracking table 118 which indicates the CTU bit value for a command associated with an entry (e.g., the command described in column 214). In accordance with one or more implementations, executing the additional command triggered by an entry in the tracking table 118 causes the processing-in-memory component 112 to output an additional result 128.

The system 100 is further depicted as including memory controller 130. The memory controller 130 is configured to receive commands (e.g., command 126) from the host 102 (e.g., from a core 108 of the host 102) and schedule the commands for execution by the processing-in-memory component 112. Although depicted in the example system 100 as being implemented separately from the host 102, in some implementations the memory controller 130 is implemented locally as part of the host 102. The memory controller 130 is further configured to schedule commands for a plurality of hosts, despite being depicted in the illustrated example of FIG. 1 as serving only a single host 102. For instance, in an example implementation the memory controller 130 schedules commands for execution by a plurality of different processing-in-memory components for a plurality of different hosts, where each of the plurality of different hosts include one or more cores that send commands for execution by processing-in-memory components. The memory controller 130 is further configured to schedule non-processing-in-memory requests for the host 102 (e.g., requests for data stored in memory 110 used in executing operations locally at the host 102).

In some implementations, the command trigger unit 116 is configured to inform the host 102 when execution of the command 126, and optionally one or more additional commands triggered as a result of executing the command 126, is complete. Such information is represented in the illustrated example of FIG. 1 as notification 132. The notification 132 enables the host 102 to resume fine-grain scheduling of commands for execution by the processing-in-memory component 112. In implementations where the memory module 104 is configured to include multiple processing-in-memory components that simultaneously execute the command 126, each processing-in-memory component is configured to transmit a separate notification 132 to the host 102. The host 102 is configured to track receipt of the notifications and thus identify when all processing-in-memory components have completed performing operations as part of executing the command 126 (and optionally one or more additional triggered commands).

Alternatively or additionally, the host 102 is configured to estimate a maximum execution time required by a processing-in-memory component 112 to execute operations as part of, or triggered by, executing command 126 and resume scheduling commands for execution by the processing-in-memory component 112 after expiration of the maximum execution time. Alternatively or additionally, the host 102 is configured to poll the processing-in-memory component 112 to check for completion of performing operations triggered as part of executing the command 126. In such an implementation, the command trigger unit 116 is configured to transmit the notification 132 to the host 102 in response to being polled by the host 102.

Although depicted as being transmitted directly to the host 102, in some implementations the coordinator 122 is configured to transmit the notification 132 to the memory controller 130. When the memory controller 130 schedules the command 126 for execution by the processing-in-memory component 112, the memory controller 130 assumes a fixed latency (e.g., as mandated by DRAM timings). Because the command trigger unit 116 is configured to trigger execution of one or more additional processing-in-memory commands, such triggering conflicts with the memory controller's assumed fixed latency. Thus, the coordinator 122 is configured to provide the notification 132 to the memory controller 130 with information indicating that an additional command has been triggered for execution by the processing-in-memory component 112. This notification 132 thus prevents the memory controller 130 from inadvertently scheduling commands for execution by the processing-in-memory component 112 while the processing-in-memory component 112 is busy executing additional commands triggered by the command trigger unit 116.

Alternatively or additionally, in some implementations the host 102 informs the memory controller 130 that one or more additional commands may be triggered for execution at the processing-in-memory component 112 in response to the processing-in-memory component 112 executing the command 126. To do so, the host 102 is configured to include one or more bits in the command 126 (e.g., one or more “bank busy” bits), which notify the memory controller 130 that, for an amount of time specified by the “bank busy” bits, it is possible that the processing-in-memory component 112 will be running internally generated commands. In this manner, the host 102 and the command trigger unit 116 are configured to inform the memory controller 130 as to appropriate timings for scheduling commands in the event additional commands are locally triggered at the processing-in-memory component 112.

Advantageously, the command trigger unit 116 enables the host 102 to concurrently execute other operations (e.g., operations of a compute-intensive workload) while the processing-in-memory component 112 is executing locally triggered commands (e.g., commands that involve operations of a data-intensive workload). Because additional commands are triggered locally at the processing-in-memory component 112, triggering and executing the additional commands does not create traffic on the interface 106, which frees bandwidth for the host 102 to retrieve data from, and write data to, memory 110 involved with executing operations locally at the host 102.

Although described above in the context of a tracking table 118 entry pertaining to a data storage location that includes a single value (e.g., a scalar register), the techniques described herein extend to data storage locations that include different values (e.g., general purpose registers). As such, the described techniques enable fine-grain processing-in-memory branching, where branching occurs on a per-data-element basis. Such fine-grain processing-in-memory branching occurs in implementations where different lanes of the processing-in-memory component 112 match with different values maintained in a data storage location. To address such scenarios, the coordinator 122 is configured to identify different commands triggered for execution by the processing-in-memory component 112 based on different lanes of the processing-in-memory component 112, and schedules the triggered commands for execution by their corresponding lanes, which does not include any hierarchical DRAM component that is currently involved in processing-in-memory component 112 operations.

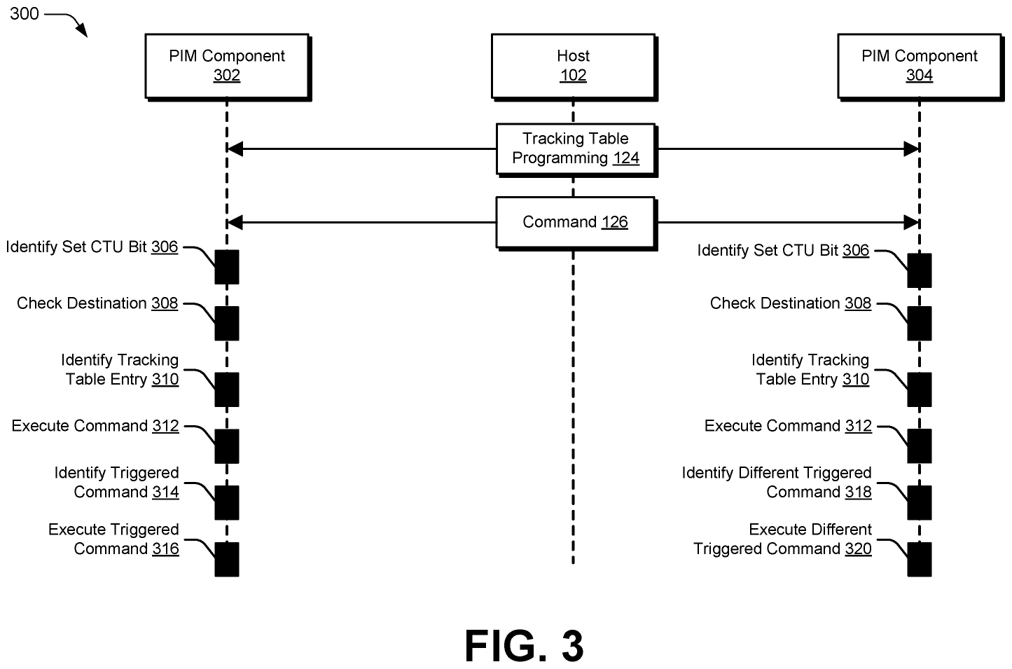

As a specific example of this fine-grain processing-in-memory branching, a 256-bit processing-in-memory component 112 is representable as sixteen different 16-bit lanes when dealing with 16-bit data. In implementations where the command 126 causes the processing-in-memory component 112 to operate on 16 different data elements simultaneously, it is possible for 16 different result values to be generated in 16 different lanes of a single general-purpose register. In such an implementation, the 16 different values are evaluated against conditions specified in the tracking table 118, which can each in turn cause triggering of additional commands executed by a respective lane of the processing-in-memory component 112. Functionality of the command trigger unit 116 is described in further detail below with respect to FIG. 3.

FIG. 3 depicts an example 300 of different processing-in-memory components using command trigger units to dynamically respond to a command received from a host.

The illustrated example 300 includes the host 102, a processing-in-memory component 302, and a processing-in-memory component 304. The processing-in-memory component 302 and the processing-in-memory component 304 each represent an instance of the processing-in-memory component 112 described with respect to FIG. 1. The host 102 is depicted as sending tracking table programming 124 to the processing-in-memory component 302 and the processing-in-memory component 304, thus initializing tracking tables of the respective processing-in-memory components, and optionally values maintained in data storage locations accessible by the respective processing-in-memory components.

The host 102 is further illustrated as broadcasting the command 126 to both the processing-in-memory component 302 and the processing-in-memory component 304. Upon receipt of the command 126, the processing-in-memory component 302 and the processing-in-memory component 304 are each configured to identify whether a CTU bit of the command 126 is set (block 306). In the example 300, a CTU bit of the command 126 is set (e.g., assigned a value of one), instructing a command trigger unit 116 of each respective processing-in-memory component to extract a data storage location identifier corresponding to a destination operand of the command 126. The extracted data storage location identifier corresponding to the destination operand of the command 126 is then used to check whether the destination corresponds to a data storage location specified in an entry of the tracking table 118 (block 308).

The processing-in-memory component 302 and the processing-in-memory component 304 are each depicted as identifying a tracking table entry that corresponds to the checked destination for the command 126 (block 310). The processing-in-memory component 302 and the processing-in-memory component 304 are each further illustrated as executing the command 126 (block 312). Although described and illustrated as occurring after performing operations corresponding to block 306, block 308, and block 310, in some implementations the respective processing-in-memory components are configured to execute the command 126 prior to one or more of the operations represented by block 306, block 308, or block 310.

In the illustrated example of FIG. 3, while the processing-in-memory component 302 and the processing-in-memory component 304 perform the same operations (e.g., as represented by block 306, block 308, block 310, and block 312) as one another, functionality performed by the different processing-in-memory components diverges responsive to executing the command 126. Specifically, the illustrated example depicts a scenario where respective entries of the different processing-in-memory components' tracking tables trigger execution of different commands. For instance, in the example 300 the processing-in-memory component 302 is depicted as identifying a triggered command based on conditions associated with an entry of its tracking table 118, responsive to executing the command 126 (block 314).

As a specific example, consider a scenario where the data storage location identified by the destination operand of the command 126 indicates “Register A,” and the processing-in-memory component 302 includes a scalar register zero (SRO) having a value set to zero. In this example scenario, a command trigger unit 116 of the processing-in-memory component 302 is configured to identify that the triggered command of column 214 for the entry of row 202 in the example tracking table 118 of FIG. 2 should be triggered for execution by the processing-in-memory component 302. Continuing this example scenario, the processing-in-memory component 302 is then caused to locally trigger a command (block 316) to perform an ADD operation at registers three, four, and five, as indicated by column 214 for the entry of row 202 in the example tracking table 118 of FIG. 2.

Conversely, the processing-in-memory component 304 is depicted as identifying a different triggered command based on conditions associated with an entry of its respective tracking table 118, responsive to executing the command (block 318). Continuing the example scenario above, where the data storage location identified by the destination operand of the command 126 indicates “Register A,” the processing-in-memory component 304 includes a scalar register zero (SRO) having a value set to one. In this example scenario, a command trigger unit 116 of the processing-in-memory component 304 is configured to identify that the triggered command of column 214 for the entry of row 204 in the example tracking table 118 of FIG. 2 should be triggered for execution by the processing-in-memory component 304. The processing-in-memory component 304 is then caused to locally trigger a command (block 320) to perform a subtract operation at registers three, four, and five, as indicated by column 214 for the entry of row 204 in the example tracking table 118 of FIG. 2.

In this manner, the techniques described herein enable simultaneous performance of divergent processing-in-memory commands by different processing-in-memory components, which would otherwise require a host to issue multiple commands using conventional system architectures. By reducing a number of commands that a host is required to send to different processing-in-memory components, the techniques described herein advantageously increase bandwidth of a connection (e.g., interface 106) coupling the host with the different processing-in-memory components and allow the host to simultaneously execute local operations while the processing-in-memory components execute divergent commands.

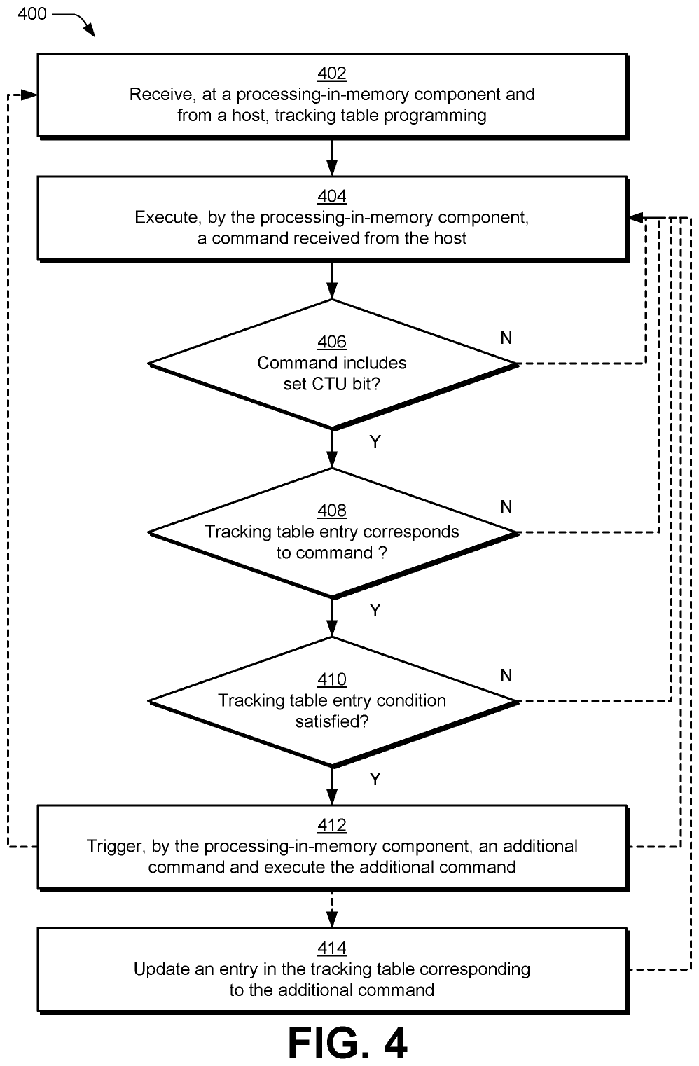

FIG. 4 depicts a procedure 400 in an example implementation of dynamically triggering execution of commands locally at a processing-in-memory component.

Tracking table programming is received at a processing-in-memory component from a host (block 402). The processing-in-memory component 112, for instance, receives tracking table programming 124 from the host 102 and updates entries of a tracking table 118 based on the tracking table programming 124. The processing-in-memory component then executes a command received from the host (block 404). The processing-in-memory component 112, for instance, executes command 126.

As part of executing the command, a determination is made as to whether the command includes a set CTU bit (block 406). The command trigger unit 116, for instance, identifies a value of a CTU bit in the command 126 received from the host 102. In response to identifying that the CTU bit is not set (e.g., is assigned a value of zero), a “No” determination is made at block 406 and operation of the procedure 400 optionally returns to block 404 for executing a subsequent command from the host, as indicated by the dashed arrow returning to block 404 from block 406. In response to identifying that the CTU bit is set (e.g., is assigned a value of one), a “Yes” determination is made at block 406.

In response to a yes determination at block 406, a determination is made as to whether a tracking table entry corresponds to the command (block 408). The condition evaluator 120 for instance, identifies whether a data storage location associated with the command 126 (e.g., a data storage location from which data is read as part of performing one or more operations as part of executing the command 126 or a data storage location to which a result 128 generated from executing the command 126 is to be written) corresponds to a data storage location listed in an entry of the tracking table 118 (e.g., an entry in column 206). In response to identifying that the command does not correspond to a tracking table entry, a “No” determination is made at block 408 and operation of the procedure 400 optionally returns to block 404 for executing a subsequent command from the host, as indicated by the dashed arrow returning to block 404 from block 408. In response to identifying that the command does correspond to a tracking table entry, a “Yes” determination is made at block 408.

In response to a “Yes” determination at block 408, a determination is made as to whether conditions for the tracking table entry are satisfied (block 410). The condition evaluator 120, for instance, identifies whether an enable field for the entry is set to true, whether a depth value for the entry indicates that triggering of a command described by the entry is permitted, and whether any specific conditions for the entry (e.g., as described in column 208) are satisfied. In response to identifying that one or more conditions of a tracking table entry are not satisfied, a “No” determination is made at block 410 and operation of the procedure 400 optionally returns to block 404 for executing a subsequent command from the host, as indicated by the dashed arrow returning to block 404 from block 410. In response to identifying that conditions of the tracking table entry are satisfied, a “Yes” determination is made at block 410.

Responsive to identifying that conditions of a tracking table entry are satisfied, the processing-in-memory component triggers an additional command and executes the additional command (block 412). For instance, in response to identifying that the conditions of the tracking table entry represented by row 202 in FIG. 2 are satisfied, the processing-in-memory component 112 triggers and executes the processing-in-memory ADD operation at the three registers, as identified by the information set forth in the tracking table 118 cell corresponding to row 202 and column 214.

An entry in the tracking table corresponding to the additional command is then optionally updated (block 414). The coordinator 122, for instance, updates information in the enable field represented by column 210, the depth value represented by column 212, or a combination thereof for the entry represented by row 202 to reflect triggering and execution of the additional command. Performance of block 414 is optional, as the coordinator 122 refrains from updating or otherwise modifying the tracking table entry in scenarios where the depth value for the entry indicates that unlimited triggering of the additional command is permitted. In response to triggering and executing the additional command, and optionally updating the tracking table entry corresponding to the additional command, operation of the procedure 400 optionally returns to block 404 for executing a subsequent command from the host, as indicated by the dashed arrows returning to block 404 from block 412 and block 414.

Alternatively or additionally, operation of the procedure 400 optionally returns to block 402, where the tracking table 118 is updated in response to receiving updated tracking table programming 124 from the host 102. In this manner, the different flows of operations illustrated in procedure 400 are configured to dynamically proceed to different commands received from a host 102 during execution of an application at the host.

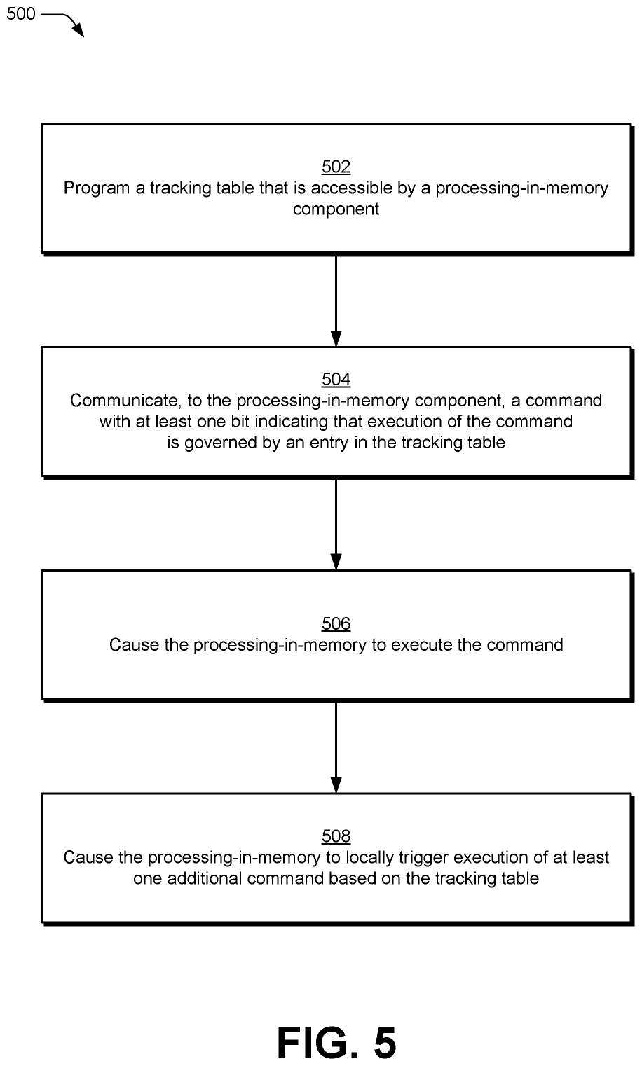

FIG. 5 depicts a procedure 500 in an example implementation of causing a processing-in-memory component to locally trigger execution of additional commands based on a command sent from a host to the processing-in-memory component.

A tracking table that is accessible by a processing-in-memory component is programmed (block 502). The host 102, for instance, populates one or more entries of the tracking table 118 by communicating the tracking table programming 124 to the command trigger unit 116 of the processing-in-memory component 112.

A command is then communicated to the processing-in-memory component with at least one bit indicating that execution of the command is governed by an entry in the tracking table (block 504). The host 102, for instance, communicates the command 126 to the processing-in-memory component 112 with a CTU bit set to one, which instructs the command trigger unit 116 to evaluate whether executing the command 126 triggers execution of an additional command locally at the processing-in-memory component 112. In response to communicating the command to the processing-in-memory component, the processing-in-memory component is caused to execute the command (block 506).

The processing-in-memory component is then caused to locally trigger execution of at least one additional command based on the tracking table (block 508). The command trigger unit 116 of the processing-in-memory component 112, for instance, is configured to identify that executing the command 126 corresponds to a data storage location for an entry in the tracking table 118, that conditions of the entry are satisfied, and trigger execution of an additional command described by the entry in response to identifying that the entry conditions are satisfied. Execution of the additional command is triggered and scheduled for execution by the processing-in-memory component 112.

The example techniques described herein are merely illustrative and many variations are possible based on this disclosure. Although features and elements are described above in particular combinations, each feature or element is usable alone without the other features and elements or in various combinations with or without other features and elements.

The various functional units illustrated in the figures and/or described herein (including, where appropriate, the host 102 having the core 108, the memory controller 130, the memory module 104 having the memory 110 and the processing-in-memory component 112, and the registers 114 and the command trigger unit 116 of the processing-in-memory component 112) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A device comprising:
a processing-in-memory component configured to:
receive a command;
generate an output by executing the command; and
execute at least one additional command based on an entry of a tracking table, the entry being associated with an operation performed as part of executing the command.

2. The device of claim 1, wherein the operation comprises providing the output to a destination, wherein the command is received with information identifying the destination and the at least one additional command is executed in response to writing the output to the destination.

3. The device of claim 2, wherein the destination comprises a storage location local to the processing-in-memory component or a location in memory of a memory module implementing the processing-in-memory component.

4. The device of claim 1, wherein the operation comprises reading data from a location and executing the at least one additional command is performed in response to reading the data from the location.

5. The device of claim 1, wherein the command includes a command trigger bit and the processing-in-memory component executes the at least one additional command in response to the command trigger bit being a predefined value.

6. The device of claim 1, wherein the at least one additional command is executed in response to the processing-in-memory component identifying that a condition in the entry is satisfied.

7. The device of claim 6, wherein the condition in the entry is satisfied responsive to a data storage location, other than a destination for the output of the command, storing a value indicated in the entry of the tracking table.

8. The device of claim 1, further comprising a memory controller, wherein the processing-in-memory component is further configured to instruct the memory controller to delay scheduling of additional commands in response the at least one additional command being executed based on the entry of the tracking table.

9. The device of claim 1, wherein the tracking table is stored locally at the processing-in-memory component or at a storage location in memory that is accessible by the processing-in-memory component.

10. The device of claim 1, wherein the tracking table is programmed by a host from which the command is received.

11. The device of claim 10, wherein the processing-in-memory component is further configured to transmit a notification to the host indicating performance of the at least one additional command in response to executing the at least one additional command.

12. The device of claim 1, wherein the entry of the tracking table includes a field describing a threshold number of times the at least one additional command is to be executed, wherein the processing-in-memory component is configured to execute the at least one additional command responsive to determining that the threshold number of times the at least one additional command is to be executed has not been exceeded.

13. The device of claim 1, wherein the processing-in-memory component is configured to execute the at least one additional command independent of traffic on a connection between the processing-in-memory component and a host from which the command is received.

14. The device of claim 1, further comprising a different processing-in-memory component configured to:
receive the command;
generate a different output by executing the command; and
execute another command that is different than the at least one additional command based on a different entry of the tracking table, the different entry being associated with the different output.

15. A device comprising:
a host configured to:
send a command for execution by a processing-in-memory component; and
cause the processing-in-memory component to execute an additional command based on a tracking table that is stored at the processing-in-memory component and includes an entry associated with an operation performed as part of executing the command.

16. The device of claim 15, wherein the host is further configured to program the tracking table by populating the tracking table with entries prior to sending the command.

17. The device of claim 15, further comprising a memory controller, wherein the host is configured to send the command to the memory controller for scheduling at the processing-in-memory component with an indication that the command is configured to cause execution of the additional command locally at the processing-in-memory component.

18. The device of claim 15, wherein the host is further configured to execute at least one operation while the processing-in-memory component is executing the additional command.

19. The device of claim 15, wherein the processing-in-memory component is caused to execute the additional command independent of traffic on a connection between the host and the processing-in-memory component.

20. A method comprising:
receiving, at an accelerator, a command from a host;
generating, by the accelerator, an output by executing the command; and
executing, by the accelerator, at least one additional command based on an entry of a tracking table, the entry being associated with an operation performed as part of executing the command.
